(19) United States
(12) Patent Application Publication
(10) Pub. No.: US 2007/0174075 A1
(43) Pub. Date: Jul. 26, 2007

(54) Tamper sensitive warranty management for autonomic computing systems

(75) Inventors: Jeffery M. Franke, Apex, NC (US); Michael S. Rollins, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/339,867

(22) Filed: Jan. 25, 2006

(51) Int. Cl. G06Q 99/00

(52) U.S. Cl. 705/1

(57) ABSTRACT

Embodiments of the present invention address deficiencies of the art in respect to warranty management and provide a method, system and computer program product for tamper sensitive warranty management for autonomic computing systems. In one embodiment of the invention, a method for tamper sensitive warranty management for an autonomic computing system can include monitoring an autonomic element within a product for configuration changes to the autonomic element. Responsive to detecting a configuration change to the autonomic element, the detected configuration change can be reported for evaluation in voiding a warranty for the product. Optionally, the configuration change can be reported to a warranty service desk over a computer communications network.

### BACKGROUND OF THE INVENTION

1. Field of the Invention

The present invention relates to the field of warranty management for computing systems and more particularly to warranty management for autonomic computing systems.

2. Description of the Related Art

A warranty ordinarily refers to a written guarantee of the integrity of a product and of the responsibility of the manufacturer for the repair or replacement of the product should the entire product or a portion of the product be determined to be defective. For most consumer items manufactured within the modem industrial world, at least some form of warranty applies. In fact, in many legal systems, the manufacturer cannot waive basic aspects of a warrant for a new product. Regardless, the more expensive the product, the more important the warranty can be perceived by consumers in selecting a product for purchase among a number of competitive products.

Servicing a warranty for a product can be expensive. Generally, warranty service can involve not only the replacement of a previously manufactured portion of a product, or perhaps the entire product, with a newly manufactured equivalent, but also the warranty service can include the diagnosis, installation and delivery of the repaired product. As such, for simplistic products, servicing a warranty can be best performed merely by providing a new replacement for a defective product without confirming the nature of the defect. For more complex products like computing systems, however, oftentimes the process of diagnosis, service and delivery cannot be avoided.

Servicing a warranty for more complex computing equipment can be particularly expensive given the importance of providing a timely resolution to a customer and the technical expertise required by warranty service personnel in order to diagnose a defect. Consequently, for more complex computing systems, defect avoidance and remediation systems often are incorporated in the design of complex computing systems. Such defect avoidance and remediation systems seek to prevent computing states likely to cause damage to a computing system, and in consequence, to require warranty service. Exemplary defect avoidance and remediation systems include thermal crisis detection logic, fan control logic, power domain load balancing logic, power domain over-subscription detection logic, and configuration safety check logic.

Advanced forms of complex computing systems extend defect avoidance and remediation systems to behave autonomically. The crux of autonomic computing relates to eight principal characteristics:

I. The system must “know itself” and include those system components which also possess a system identify.

II. The system must be able to configure and reconfigure itself under varying and unpredictable conditions.

III. The system must never settle for the status quo and the system must always look for ways to optimize its workings.

IV. The system must be self-healing and capable of recovering from routine and extraordinary events that might cause some of its parts to malfunction.

V. The system must be an expert in self-protection.

VI. The system must know its environment and the context surrounding its activity, and act accordingly.

VII. The system must adhere to open standards.

VIII. The system must anticipate the optimized resources needed while keeping its complexity hidden from the user.

Notwithstanding the advancement of autonomic defect detection and remediation, customers occasionally disable the operation of autonomic defect detection and remediation elements of a computing system. Sometimes, customers do so to achieve enhanced performance—even at the expense of the reliability of the computing system and the ability of the computing system to recover from a fault condition. Other times, customers disable autonomic defect detection and remediation elements inadvertently or without knowledge of the real benefit of the autonomic defect detection and remediation elements.

Diagnosing a defect in a computing system rendered vulnerable through a disabling of autonomic defect detection and remediation elements cannot be easily undertaken. Consequently, the manufacturer often pays the price economically for the actions of the consumer. For many conventional products, tampering with the internal workings of a product suffices to void the warranty. Detecting customer tampering with a product can be as simple as visually inspecting the integrity of a seal applied to the product casing. However, in the case of disabling autonomic defect detection and remediation features of a computing system, a visual inspection will not suffice.

### BRIEF SUMMARY OF THE INVENTION

Embodiments of the present invention address deficiencies of the art in respect to warranty management and provide a novel and non-obvious method, system and apparatus for tamper sensitive warranty management for autonomic computing systems. In one embodiment of the invention, a method for tamper sensitive warranty management for an autonomic computing system can include monitoring an autonomic element within a product for configuration changes to the autonomic element. Responsive to detecting a configuration change to the autonomic element, the detected configuration change can be reported for evaluation in voiding a warranty for the product. Optionally, the configuration change can be reported to a warranty service desk over a computer communications network.

In one aspect of the invention, monitoring an autonomic element within a product for configuration changes to the autonomic element, can include monitoring an autonomic element for a field replaceable unit (FRU) or customer replaceable unit (CRU) within a product for configuration changes to the autonomic element. Likewise, in another aspect of the invention, reporting the detected configuration change for evaluation in voiding a warranty for the product, can include recording each of an autonomic element, FRU, and configuration change within a configuration change data structure. Optionally, the configuration change data structure can be stored in the FRU or CRU. In either case, the warranty for the product can be voided responsive to detecting a configuration change to the autonomic element.

In another embodiment of the invention, an autonomic data processing system disposed in a product can include an autonomic element and a warranty management client coupled to the autonomic element. The warranty management client can include program code enabled to monitor the autonomic element for configuration changes to the autonomic element. The program code further can be enabled to change to the autonomic element responsive to detecting a configuration change. Additionally, the program code can be enabled to report the detected configuration change for evaluation in voiding a warranty for the product.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an autonomic data processing system configured for tamper sensitive warranty management; and,

FIG. 2 is a flow chart illustrating a process for tamper sensitive warranty management for autonomic computing systems.

### DETAILED DESCRIPTION OF THE INVENTION

Embodiments of the present invention provide a method, system and computer program product for tamper sensitive warranty management for autonomic computing systems. In accordance with an embodiment of the present invention, configuration changes to an autonomic computing system within a product can be detected. The changes can be recorded to a data structure for the autonomic computing system and provided to warranty management service desk. The changes can be evaluated to determine whether or not a warranty for a product incorporating the autonomic computing system is to be voided. If so, the warranty can be voided due to the configuration change. Notably, the product can range from a high performance computing system such as a BladeCenter(TM) manufactured by International Business Machines Corporation of Armonk, N.Y., United States, to a computing system disposed within a vehicle such as an automobile.

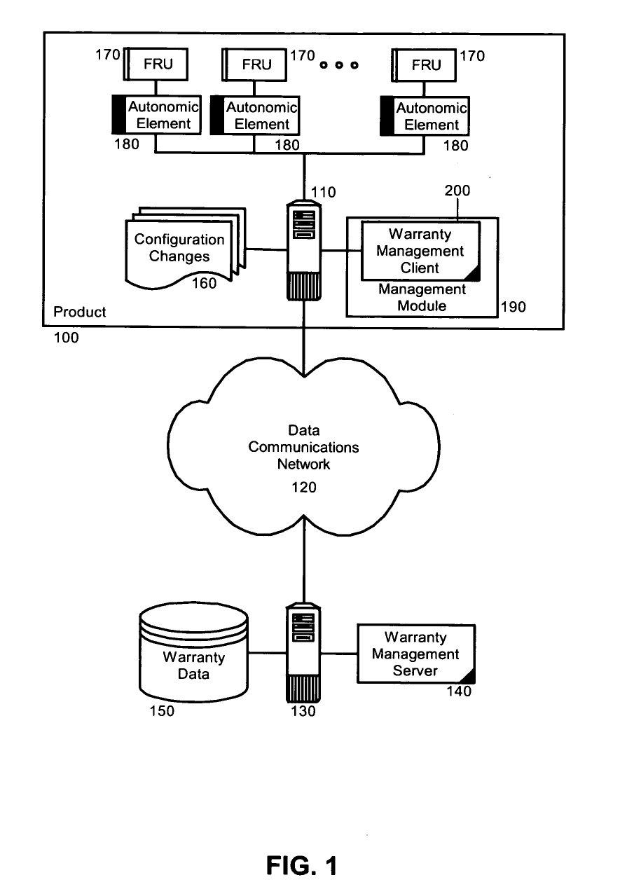

In illustration, FIG. 1 is a schematic illustration of an autonomic data processing system configured for tamper sensitive warranty management. As shown in FIG. 1, a product 100 can include an autonomic data processing system 110 coupled to one or more field replaceable units (FRUs) 170. A management module 190 can be coupled to the autonomic data processing system 110 and can include program code enabled to manage the addition, removal, and configuration of individual ones of the FRUs 170. Notably, though only a single autonomic data processing system 110 is shown for illustrative simplicity, it will be recognized by the skilled artisan that multiple instances of the autonomic data processing system 110 can accommodate multiple FRUs 170 and can be managed by one or more instances of the management module 190.

Selected ones of the FRUs 170 can be coupled to an autonomic element 180. The autonomic element 180 can be logic including program code enabled to behave autonomically in the operation of a coupled one of the FRUs 170. For instance, an autonomic element 180 can include program code enabled to detect a condition likely to give rise to a failure or a failure as the failure occurs. Also, an autonomic element 180 can include program code enabled to remediate a condition likely to give rise to a failure or a failure once the failure has occurred. It is to be recognized by one skilled in the art that each autonomic element 180 can exist separately for a corresponding FRU 170, or a single autonomic element 180 can exist for groups of the FRUs 170. In this regard, in one embodiment, the autonomic elements 180 can be included in the management module 190.

Importantly, a warranty management client 200 can be coupled to the management module 190. The warranty management client 200 can include program code enabled to monitor changes in the configuration of the autonomic elements 180 of the respective FRUs 170. Whenever a change to the configuration of an autonomic element 180 is detected, the warranty management client 200 can record the detected change within a configuration change data structure 160 for the autonomic element 180 associated with the detected change. In this way, impermissible changes to the configuration of an autonomic element 180 can be recognized in determining whether or not to void the warranty for the product 100.

Optionally, the autonomic data processing system 110 can be coupled to a warranty service desk 130 over a computer communications network 120. The warranty service desk 130 can include a data store of warranty data 150 for different products for different customers, and a warranty management server 140. In particular, the warranty management server 140 can include program code enabled to identify within a configuration change data structure 160 the identity of an affected product, a subject FRU and corresponding autonomic element, and the nature of the configuration change. As such, the warranty management server 140 can process configuration changes reflected within a configuration change data structure 160 in order to determine whether or not to void a warranty for a corresponding product 100.

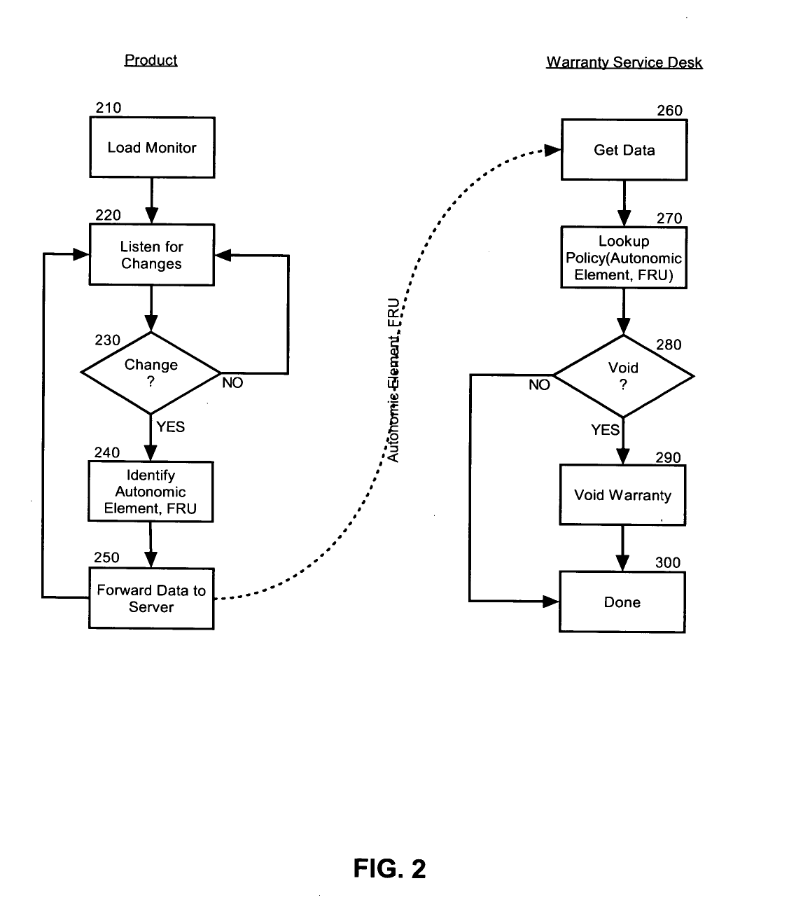

In further illustration, FIG. 2 is a flow chart illustrating a process for tamper sensitive warranty management for an autonomic computing system. Beginning in block 210, a monitor can be loaded to monitor autonomic elements for respective FRUs for configuration changes. In block 220, the monitor can listen for changes in the autonomic elements for the respective FRUs. In decision block 230, if a change is detected, in block 240 the autonomic element FRU affected by the change can be identified and stored along with the detected configuration change within a change data structure. Subsequently, in block 250, the change data structure can be forwarded to the warranty service desk.

Within the warranty service desk, in block 260 the affected autonomic element and FRU, along with the configuration change, can be identified within the received change data structure. Subsequently, in block 270 a policy can be searched for the configuration change, autonomic element and FRU in order to determine the impact of the configuration change upon an associated warranty. In decision block 280, if the policy calls for a voiding of the warranty based upon the configuration change, in block 290 the warranty can be voided and recorded in the warranty service desk. Thereafter, the process can end in block 300.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for tamper sensitive warranty management for an autonomic computing system, the method comprising:
monitoring an autonomic element within a product for configuration changes to the autonomic element; and,
responsive to detecting a configuration change to the autonomic element, reporting the detected configuration change for evaluation in voiding a warranty for the product.

2. The method of claim 1, wherein monitoring an autonomic element within a product for configuration changes to the autonomic element, comprises monitoring an autonomic element for a field replaceable unit (FRU) within a product for configuration changes to the autonomic element.

3. The method of claim 2, wherein reporting the detected configuration change for evaluation in voiding a warranty for the product, comprises recording each of an autonomic element, FRU, and configuration change within a configuration change data structure.

4. The method of claim 3, wherein recording each of an autonomic element, FRU, and configuration change within a configuration change data structure, further comprises storing the configuration change data structure in the FRU.

5. The method of claim 1, further comprising reporting the configuration change to a warranty service desk over a computer communications network.

6. The method of claim 1, further comprising voiding the warranty for the product responsive to detecting a configuration change to the autonomic element.

7. The method of claim 1, further comprising voiding the warranty for the product within the warranty service desk responsive to receiving a report of a configuration change to the autonomic element.

8. An autonomic data processing system disposed in a product, the data processing system comprising:
an autonomic element; and,
a warranty management client coupled to the autonomic element, the warranty management client comprising program code enabled to monitor the autonomic element for configuration changes to the autonomic element, and, responsive to detecting a configuration change to the autonomic element, to report the detected configuration change for evaluation in voiding a warranty for the product.

9. The system of claim 8, wherein the autonomic element comprises defect detection and remediation logic for a coupled field replaceable unit (FRU).

10. The system of claim 8, wherein the warranty management client is coupled to a management module for the autonomic data processing system.

11. The system of claim 8, wherein the warranty management is coupled to a warranty management server over a computer communications network in a warranty service desk.

12. The system of claim 8, wherein the product is a blade server computing system.

13. The system of claim 8, wherein the product is an automobile.

14. A computer program product comprising a computer usable medium having computer usable program code for tamper sensitive warranty management for an autonomic computing system, the computer program product including:
computer usable program code for monitoring an autonomic element within a product for configuration changes to the autonomic element; and,
computer usable program code for responsive to detecting a configuration change to the autonomic element, reporting the detected configuration change for evaluation in voiding a warranty for the product.

15. The computer program product of claim 14, wherein the computer usable program code for monitoring an autonomic element within a product for configuration changes to the autonomic element, comprises computer usable program code for monitoring an autonomic element for a field replaceable unit (FRU) within a product for configuration changes to the autonomic element.

16. The computer program product of claim 15, wherein the computer usable program code for reporting the detected configuration change for evaluation in voiding a warranty for the product, comprises computer usable program code for recording each of an autonomic element, FRU, and configuration change within a configuration change data structure.

17. The computer program product of claim 16, wherein the computer usable program code for recording each of an autonomic element, FRU, and configuration change within a configuration change data structure, further comprises computer usable program code for storing the configuration change data structure in the FRU.

18. The computer program product of claim 14, further comprising computer usable program code for reporting the configuration change to a warranty service desk over a computer communications network.

19. The computer program product of claim 14, further comprising computer usable program code for voiding the warranty for the product responsive to detecting a configuration change to the autonomic element.

20. The computer program product of claim 14, further comprising computer usable program code for voiding the warranty for the product within the warranty service desk responsive to receiving a report of a configuration change to the autonomic element.
